(19) United States
(12) Patent Application Publication
(10) Pub. No.: US 2014/0038018 A1
(43) Pub. Date: Feb. 6, 2014

(54) BATTERY COVER LATCHING ASSEMBLY FOR PORTABLE ELECTRONIC DEVICE

(71) Applicants: FIH (Hong Kong) Limited, Kowloon (HK); SHENZHEN FUTAIHONG PRECISION INDUSTRY CO., LTD, Shenzhen (CN)

(72) Inventors: XIAO ZHANG, Shenzhen (CN); YONG-GANG ZHANG, Shenzhen (CN); KUAN-HUNG CHEN, Shindian (TW)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/914,818

(22) Filed: Jun. 11, 2013

(30) Foreign Application Priority Data
Aug. 6, 2012 (CN) 2012102768558

(51) Int. Cl. H01M 2/10

(52) U.S. Cl. CPC H01M 2/1022
USPC 429/100

(57) ABSTRACT

A battery cover assembly for a portable electronic device includes a base body, a battery cover, a movable member, a driving rod, and an elastic member. The base body includes a block defining a guiding groove. The guiding groove includes a straight edge, a sloping edge, and a guiding portion having a clasp with a guiding edge formed in the guiding groove. The driving rod has a protrusion and is slidably engaged with the movable member. The elastic member abuts against the movable member. When the driving rod is slid along the guiding portion, the protrusion is slid along the guiding edge and is latched with the clasp to position the driving rod in a first position. When the driving rod is slid in the guiding groove, the protrusion is slid along the straight edge and the sloping edge to position the driving rod in a second position.

### BACKGROUND

1. Technical Field

The present disclosure generally relates to battery cover latching assemblies and particularly to a battery cover latching assembly for use in a portable electronic device.

2. Description of related art

Batteries are widely used in portable electronic devices, such as personal digital assistants, mobile phones, and so on. Many batteries are removably received in the electronic device, and battery covers are designed to connect to housings of the electronic devices to cover and protect the batteries. Batteries can be taken out by opening the battery covers.

Although battery cover assemblies may be simple, engagement between the battery cover and the housing of the mobile phone can be too firm, making it difficult to open the battery cover.

Therefore, there is room for improvement within the art.

### BRIEF DESCRIPTION OF THE DRAWINGS

Many aspects of the battery cover assembly can be better understood with reference to the following drawings. The components in the drawings are not necessarily drawn to scale, the emphasis instead being placed upon clearly illustrating the principles of the battery cover assembly. Moreover, in the drawings, like reference numerals designate corresponding parts throughout the several views.

FIG. 1 is an exploded, isometric view of a portable electronic device employing a battery latching cover assembly including a movable member and a driving rod in accordance with an exemplary embodiment.

FIGS. 2 to 3 are similar to FIG. 1, but shown from different aspects.

FIG. 4 is an enlarged view of a guiding groove shown in FIG. 1.

FIG. 5 is an enlarged view of the movable member and the driving rod.

FIG. 6 is a partially assembled view showing the movable member and the driving rod attached to the base body.

FIG. 7 is an assembled view of the portable electronic device.

FIG. 8 is a cross sectional view of FIG. 6 taken along line VIII-VIII.

FIGS. 9 and 10 are schematic views showing the movement positions of the movable member and the driving rod in a first locked state.

FIGS. 11 and 12 are schematic views showing the movement positions of the movable member and the driving rod in a second locked state.

### DETAILED DESCRIPTION

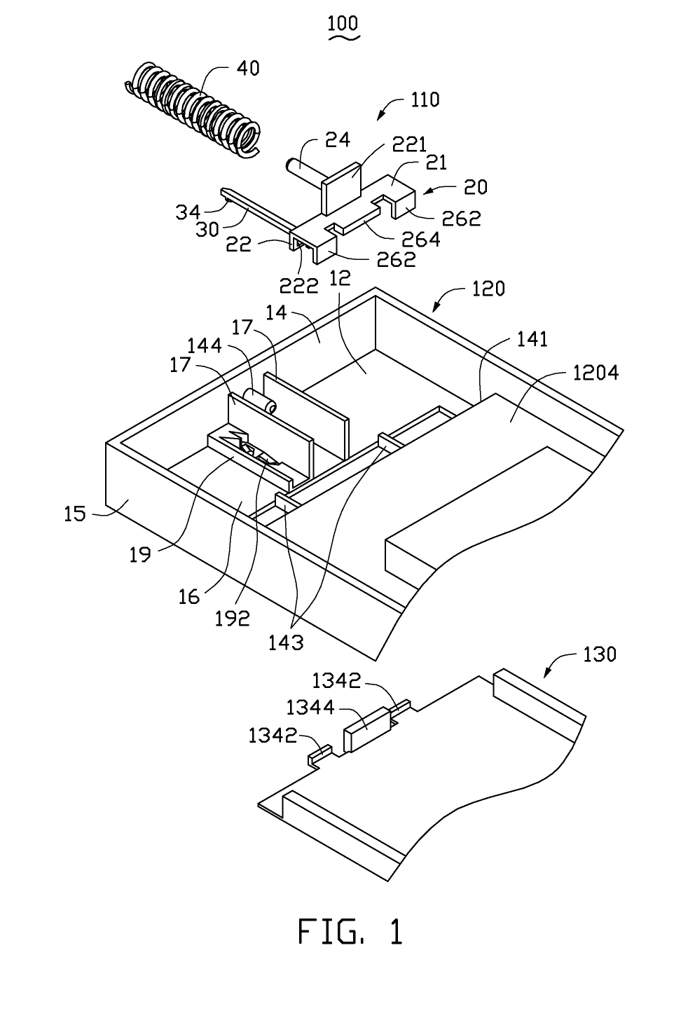

FIG. 1 shows a portable electronic device 100, such as a mobile phone. The mobile phone 100 is an exemplary application, for the purposes of describing details of an exemplary embodiment of the portable electronic device. The mobile phone 100 includes a battery cover latching assembly 110, a base body 120, and a battery cover 130. The battery cover latching assembly 110 releasably latches the battery cover 130 to the base body 120. The battery cover latching assembly 110 includes a movable member 20, a driving rod 30, and an elastic member 40.

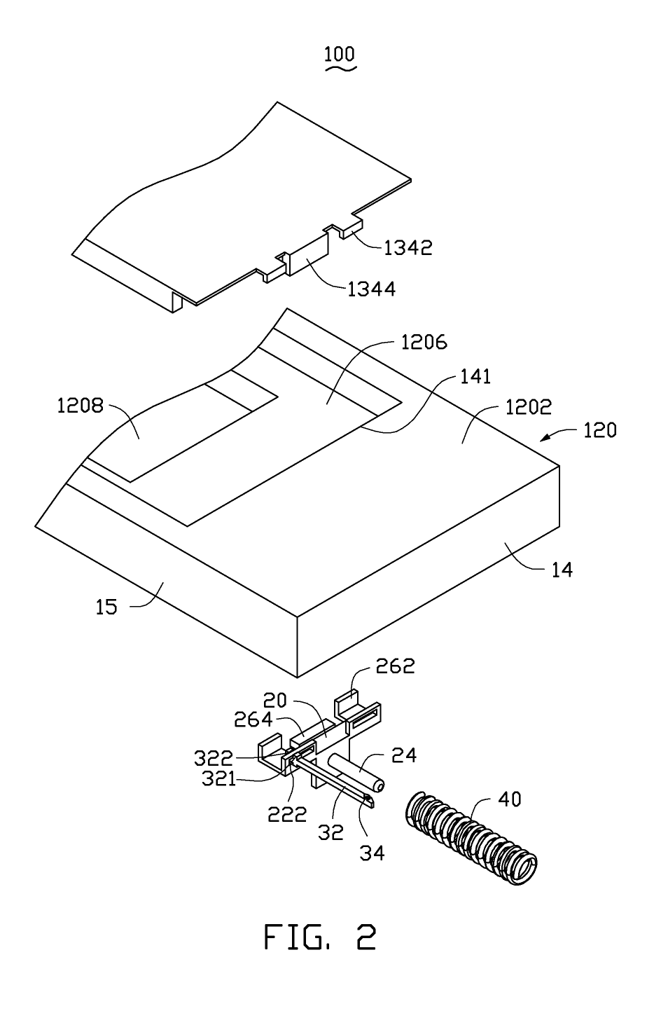

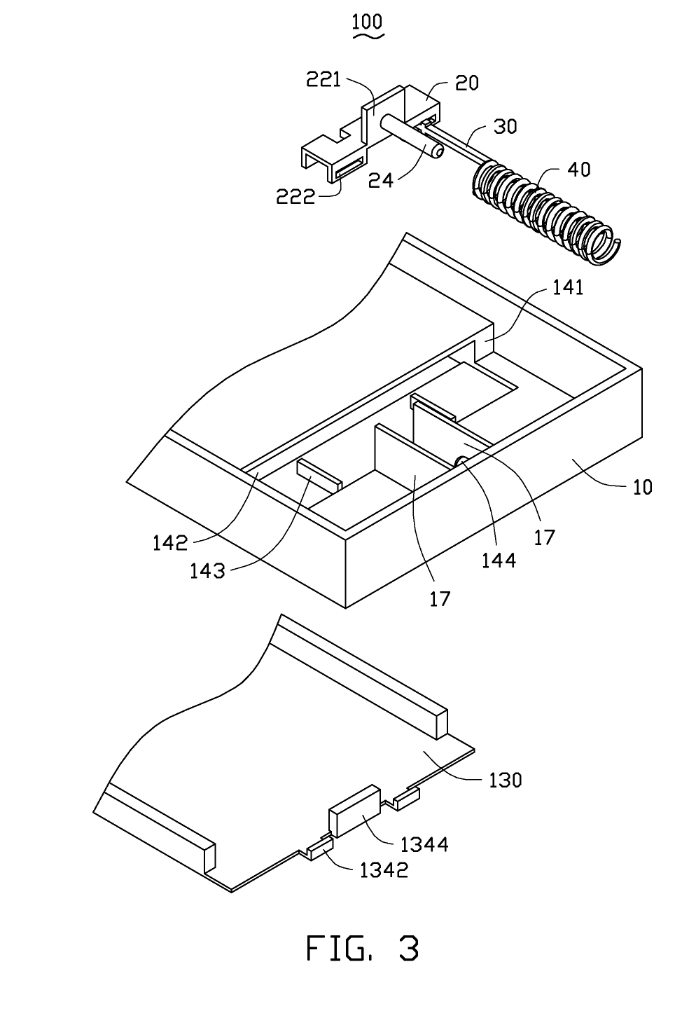

Referring to FIGS. 2 to 3, the base body 120 includes an end wall 14, two opposite sidewalls 15, a first surface 1202, and a second surface 1204 opposite to the first surface 1202. The first surface 1202 defines a cavity 1206 for receiving the battery cover 130. A bottom surface of the cavity 11 defines a battery compartment 1208 for receiving a battery (not shown). The second surface 1204 has a receiving groove 12 between the end wall 14 and one side of the cavity 1206. The cavity 1206 has a side edge 141 defining a passage 142. The passage 142 communicates an inside of the cavity 1206 with the receiving groove 12. A bottom surface 16 of the receiving groove 12 is connected to the end wall 14, the sidewalls 15, and the side edge 141.

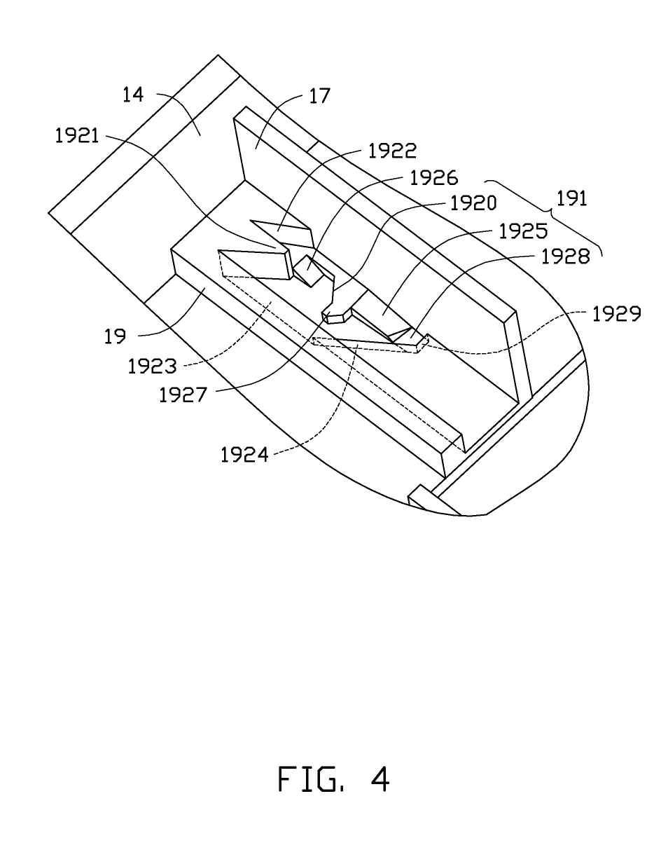

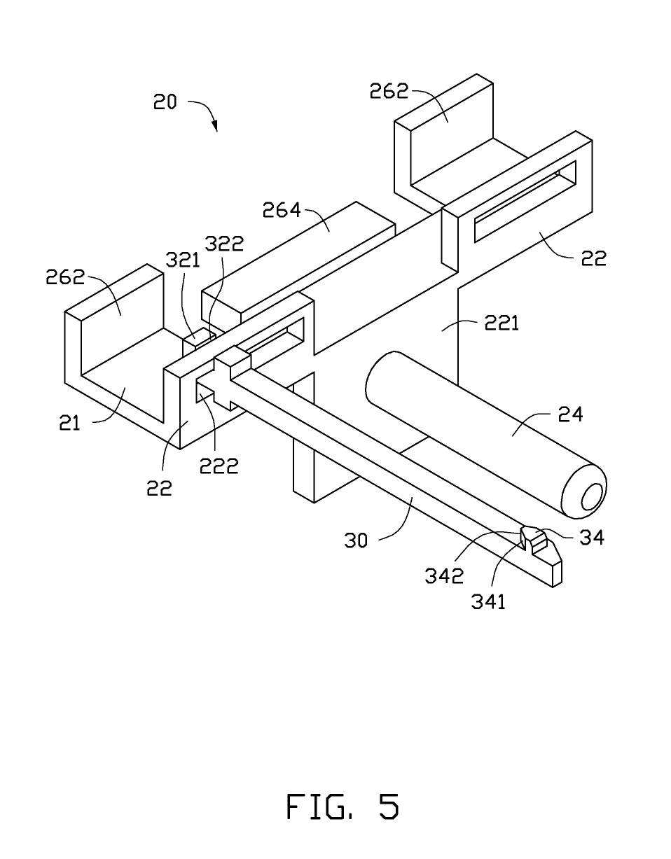

The bottom surface 16 has two spaced-apart limiting beams 143, two positioning plates 17, and a block 19 mounted in the receiving groove 12. The two limiting beams 143 are parallel to the sidewalls 15 and are adjacent to the passage 142. The two positioning plates 17 are parallel to each other and perpendicularly extend from the end wall 14 opposite to the passage 142. A post 144 extends from the end wall 14 and is located between the two positioning plates 17. The block 19 is adjacent to one of the positioning plates 17 and defines a guiding groove 192. Referring to FIG. 4, an angled projection 1921, a straight edge 1923, a sloping edge 1924, and a stopping edge 1929 cooperatively define the guiding groove 192. The angled projection 1921 is formed at one end of the guiding groove 192. Two angled grooves 1922 are defined at opposite sides of the angled projection 1921. A guiding portion 191 projects from a bottom surface of the guiding groove 192 and includes a first guiding surface 1926, a latching clasp 1927, a second guiding surface 1925 and a latching recess 1928. The first guiding surface 1926 and the second guiding surface 1925 are sloped and are respectively positioned at opposite sides of the latching clasp 1927. A highest point of the first guiding surface 1926 is coplanar with the latching clasp 1927. A highest point of the second guiding surface 1925 is coplanar with the latching clasp 1927. The latching clasp 1927 has a guiding edge 1920. The guiding edge 1920 has a vertical part, a tilted part and a horizontal part connected to each other. The vertical part is substantially parallel to the positioning plates 17 and the horizontal part is substantially parallel to the end wall 14. The tilted part is connected between the vertical part and the horizontal part. The latching recess 1928 is defined between the second guiding surface 1925 and the stopping edge 1929.

Referring to FIG. 2, the battery cover 130 has a shape corresponding to the base body 120 and configured to be attached to the base body 120. One end of the battery cover 130 has two first hooks 1342 and a first resisting portion 1344 formed between the two first hooks 1342. When the battery cover 130 is engaged in the cavity 1206 of the base body 120, the first hooks 1342 and the first resisting portion 1344 are received in the passage 142.

The movable member 20 and the driving rod 30 are used for being assembled to the base body 120 and engage with the battery cover 130. The movable member 20 has a plate body 21. Two frames 22 and an extending plate 221 are located at one side of the plate body 21. The two frames 22 extend along opposite directions. Two second hooks 262 and a second resisting portion 264 are located at an opposite side of the plate body 21. Each frame 22 defines a longitudinal slot 222. A shaft 24 perpendicularly extends from the extending plate 221.

The driving rod 30 is slidably received in the movable member 20. The driving rod 30 has two projections 321 at one end and a protrusion 34 at an opposite end. A cutout 322 is defined between the two projections 321. One of the projections 321 extends through the slot 222 of the frame 22 to be positioned at one side of the frame 22 and the other of the projections 321 is blocked by the frame 22 to be positioned at another side of the frame 22. Accordingly, the driving rod 30 is slidably engaged with the movable member 20. The protrusion 34 has two sloping surfaces 341 and a connecting surface 342. The sloping surfaces 341 are configured for engaging with the guiding portion 191 in the guiding groove 192.

The elastic member 40 is fitted around the post 144 and the shaft 24 for providing an elastic force to press the movable member 20 against the battery cover 130. In this exemplary embodiment, the elastic member 40 is a helical spring.

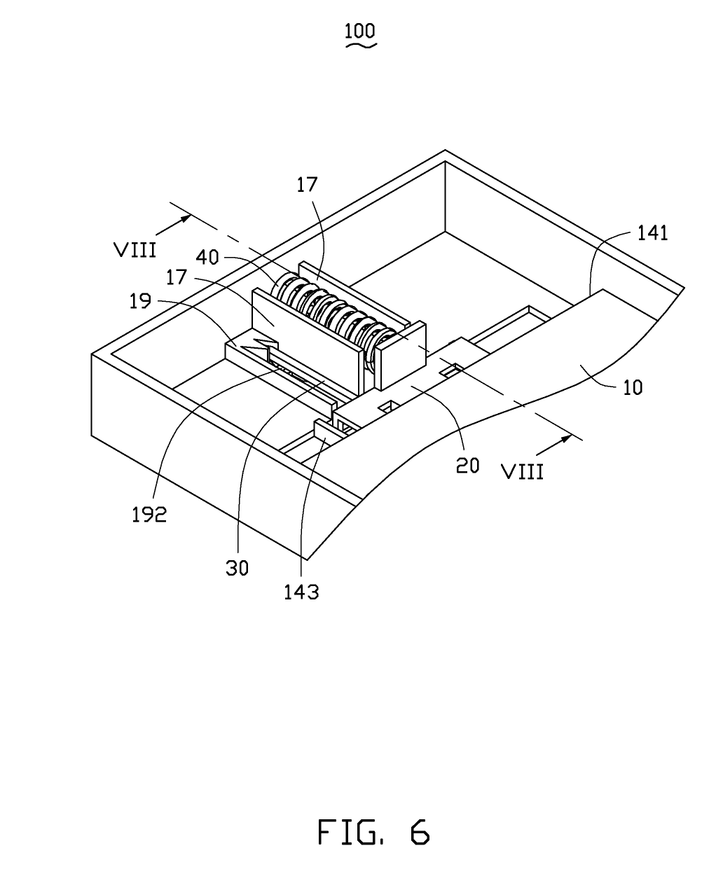

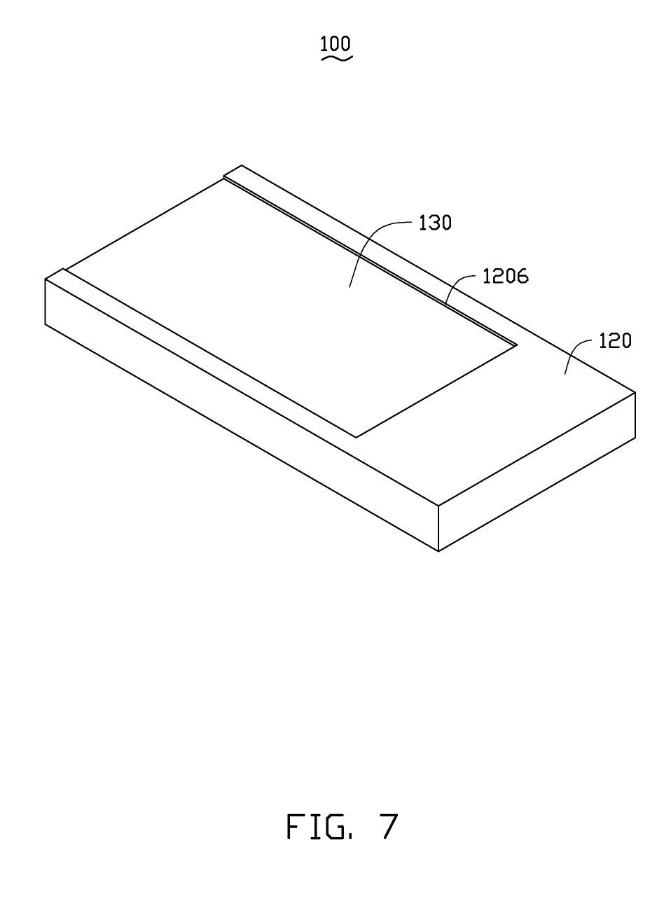

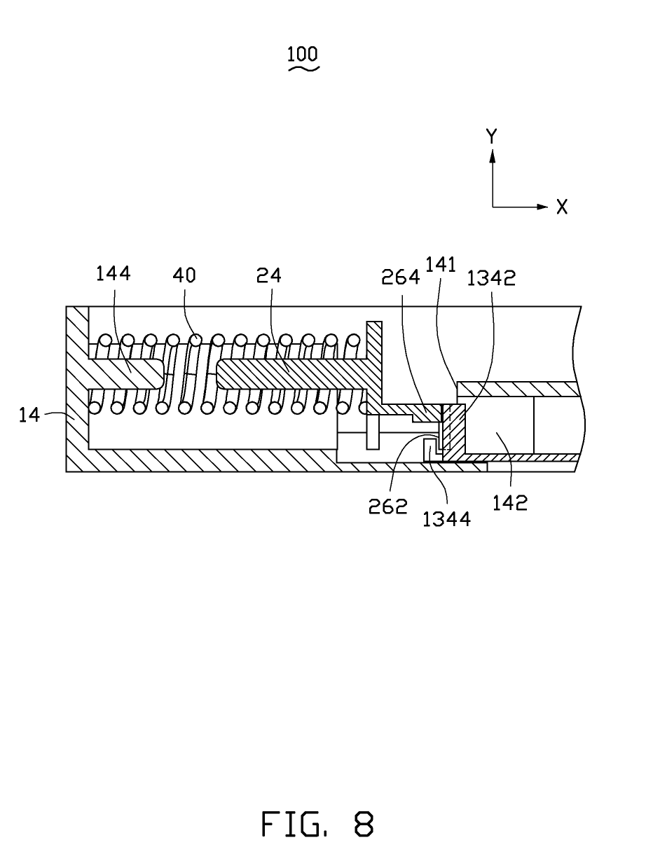

During assembly of the battery cover assembly, referring to FIGS. 6 to 8, the driving rod 30 is slidably engaged in the cutout 322. The movable member 20 and the driving rod 30 are assembled to the base body 120. The movable member 20 is positioned between two limiting beams 143, and the shaft 24 is positioned between the two positioning plates 17. The elastic member 40 is fitted around the post 144 and the shaft 24 for providing an elastic force to the movable member 20. The driving rod 30 is received in the guiding groove 192. Then, the battery cover 130 is received in the cavity 1206. The first hooks 1342 and the first resisting portion 1344 are received in the passage 142. The first hooks 1342 are engaged with the second hooks 262 and the first resisting portion 1344 abuts against the second resisting portion 264.

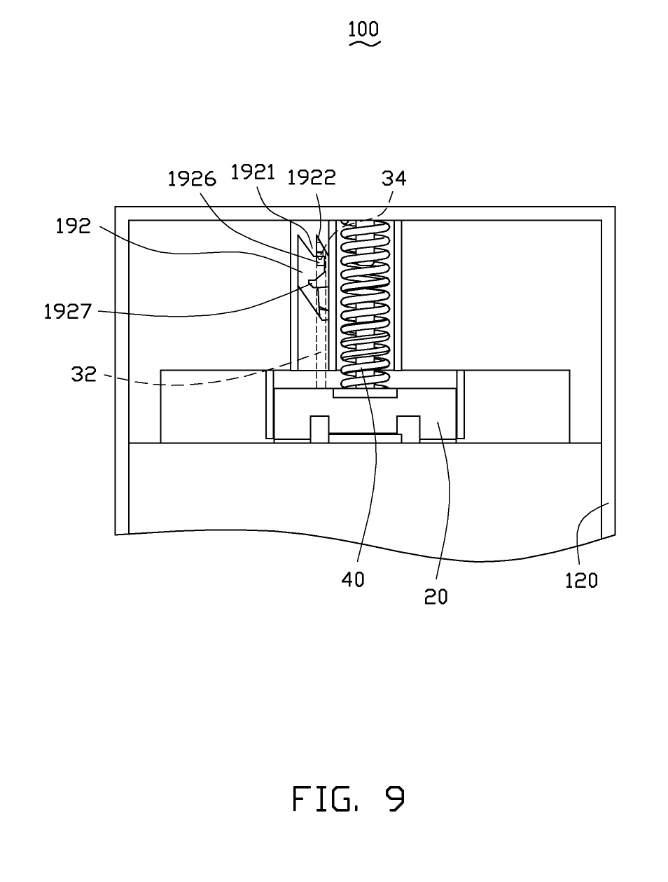

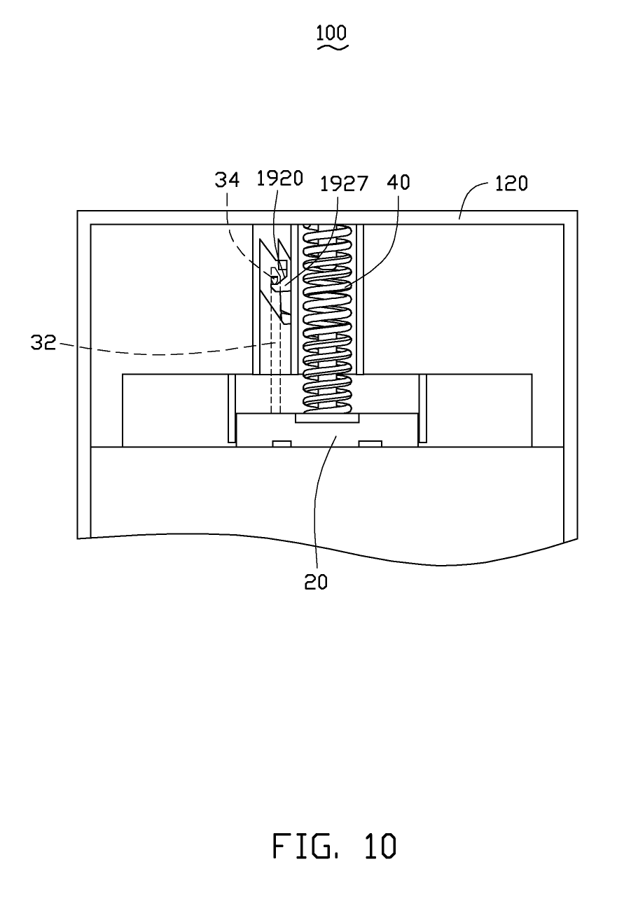

Referring to FIGS. 9 and 10, the protrusion 34 is received in the latching recess 1928. The battery cover 130 is pushed by an external force into the passage 142. The driving rod 30 is pushed to move and is guided by the second guiding surface 1925 to slide on the guiding portion 191 until the driving rod 30 is pushed to latch one end of the driving rod 30 in the angled groove 1922 adjacent to the positioning plate 17. When the external force is removed, the elastic member 40 drives the driving rod 30 to move reversely. The driving rod 30 slide along the first guiding surface 1926 and is guided by the guiding edge 1920 of the clasp 1927. The tilted part of the guiding edge 1920 guides one of the sloping surfaces 341 of the protrusion 34 to move left until the connecting surface 342 of the protrusion 34 is latched on the clasp 1927. Thus, the battery cover 130 is locked in the base body 120.

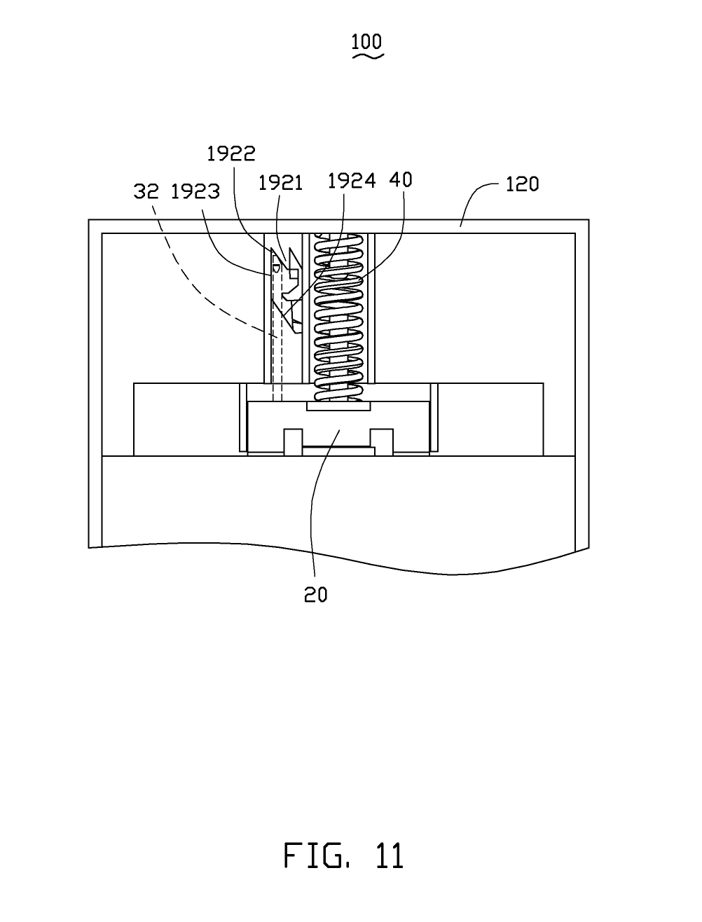

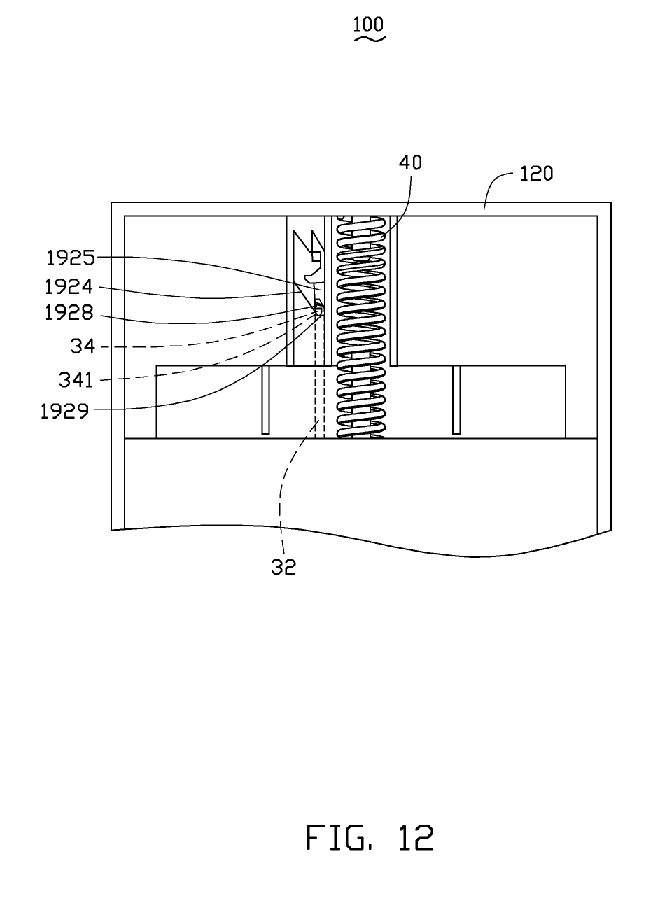

Referring to FIGS. 11 and 12, to open the battery cover 130, the user pushes the battery cover 130. The driving rod 30 is moved toward the other angled groove 1922 until the driving rod 30 is blocked by the inner wall of the other angled groove 1922 thus releasing the driving rod 30. After the driving rod 30 is released, the protrusion 34 of the driving rod 30 is guided by the straight edge 1923 and the sloping edge 1924. The other sloping surface 341 of the protrusion 34 slides along the straight edge 1923 and the sloping edge 1924 until the protrusion 34 is received in the latching recess 1928. Thus, the battery cover 30 can then be removed.

As described above, the exemplary embodiment provides a battery cover assembly for portable electronic devices, such as mobile phones. The battery cover of the battery cover assembly can be easily opened and more user-friendly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A battery cover assembly for a portable electronic device, the battery cover assembly comprising:
a base body including a block defining a guiding groove, the guiding groove includes a straight edge, a sloping edge and a guiding portion formed in the guiding groove, the guiding portion having a clasp with a guiding edge;
a movable member;
a driving rod slidably engaged with the movable member, the driving rod having a protrusion; and
an elastic member abutting against the movable member;
wherein when the driving rod is slid along the guiding portion, the protrusion is slid along the guiding edge and is latched with the clasp to position the driving rod in a first position;
when the driving rod is slid in the guiding groove, the protrusion is slid along the straight edge and the sloping edge to position the driving rod in a second position.

2. The battery cover assembly as claimed in claim 1, wherein the movable member has a plate body, two frames and an extending plate are located at one side of the plate body and extend along opposite directions, and the driving rod is slidably engaged in one of the frames.

3. The battery cover assembly as claimed in claim 2, wherein a shaft perpendicularly extends from the extending plate, and the elastic member is fitted around the shaft.

4. The battery cover assembly as claimed in claim 2, wherein the driving rod has two projections and the protrusion at opposite ends, a receiving groove is defined between the two projections for engaging with one of the frames.

5. The battery cover assembly as claimed in claim 1, wherein the base body includes two positioning plates adjacent to the block, the two positioning plates are parallel to each other, and the elastic member is positioned between the two positioning plates.

6. The battery cover assembly as claimed in claim 1, wherein the guiding groove includes an angled projection and a stopping edge, the angled projection is connected to the straight edge, the straight edge is connected to the sloping edge, and the stopping edge is connected to the sloping edge.

7. The battery cover assembly as claimed in claim 6, wherein the guiding portion projects from a bottom surface of the guiding groove and includes a first guiding surface, a second guiding surface and a latching recess, the first guiding surface and the second guiding surface are slopes and are respectively positioned at opposite sides of the clasp.

8. A portable electronic device comprising:
a base body including a guiding groove with a straight edge, a sloping edge and a guiding portion;
a battery cover;
a movable member;
a driving rod slidably engaged with the movable member; and
an elastic member abutting against the movable member;
wherein the driving rod is slid along the guiding portion and is positioned in the guiding groove in a first position; the driving rod is slid along the straight edge and the sloping edge and is positioned in the guiding groove in a second position.

9. The portable electronic device as claimed in claim 8, wherein the movable member has a plate body, two frames and an extending plate are located at one side of the plate body and extend along opposite directions, and the driving rod is slidably engaged in one of the frames.

10. The portable electronic device as claimed in claim 9, wherein a shaft perpendicularly extends from the extending plate, and the elastic member is fitted around the shaft.

11. The portable electronic device as claimed in claim 8, wherein the guiding groove includes an angled projection and a stopping edge, the angled projection is connected to the straight edge, the straight edge is connected to the sloping edge, and the stopping edge is connected to the sloping edge.

12. The portable electronic device as claimed in claim 9, wherein the guiding portion projects from a bottom surface of the guiding groove and includes a first guiding surface, a second guiding surface and a latching recess, the first guiding surface and the second guiding surface are slopes and are respectively positioned at opposite sides of the clasp.
